(19) United States
(12) Patent Application Publication
(10) Pub. No.: US 2018/0261442 A1
(43) Pub. Date: Sep. 13, 2018

(54) RF Generator Design for Mass Spectrometer

(71) Applicants: Masayuki Kamata, Sunnyvale, CA (US); William (Wei) Yang, Los Altos, CA (US)

(72) Inventors: Masayuki Kamata, Sunnyvale, CA (US); William (Wei) Yang, Los Altos, CA (US)

(73) Assignee: BaySpec, Inc., San Jose, CA (US)

(21) Appl. No.: 15/456,610

(22) Filed: Mar. 13, 2017

(51) Int. Cl. H01J 49/02; H01J 49/42

(52) U.S. Cl. CPC H01J 49/022; H01J 49/4225

(57) ABSTRACT

A high voltage RF power supply capable of supplying a varying amplitude RF signal at a fixed frequency to the electrodes of a mass spectrometer analyzer. The RF generator provides a high voltage, low current signal capable of changing its amplitude in response to an input drive signal. The RF generator circuitry comprises separate positive and negative driver channels interfaced to a class AB amplifier circuit. The separate positive and negative channels drive a pair of current amplifiers with the final output stage comprising an air-core step-up transformer. The RF generator achieves efficiency and stability with a minimum of electronics hardware while incorporating the use of a simplified RF feedback circuit. The RF generator may be used with a variety of mass spectrometer analyzers, particularly those of miniaturized or portable application.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### FIELD OF THE INVENTION

The invention relates to the field of electronics, and specifically to the electronic circuitry used to generate high voltage RF signals for driving quadrupole and ion trap mass spectrometers. The invention finds its greatest application in the field of portable mass spectrometers, where the efficiency and compact design of the RF generator provides distinct size, weight and cost advantages over conventional RF generator designs.

### BACKGROUND OF THE INVENTION

Fundamentally, the practice of mass spectrometry involves the manipulation and control of individual molecules of a substance to determine the mass-to-charge ratio, the chemical formula, the chemical structure, the isotopic ratio, the relative concentration and the amount of a specific compound present in a sample. Typically, a mass spectrometer performs this analysis by placing the sample molecules into an ionized state. Once the molecules are ionized, they may be controlled through the application of external electric and/or magnetic fields. The behavior of the ionized molecules can then be recorded and analyzed in a variety of ways to determine their mass/charge ratios and the mass/charge ratios of the fragments formed from the breakup of the original molecules of the sample. From this basic mass/charge data, information relating to the formula, structure, isotopic ratio and amount of material present can be calculated or deduced.

The mass spectrometer itself is typically composed of several different components, often operating under different pressures and different temperatures. A typical mass spectrometer includes an inlet or separation system within which the sample to be analyzed is separated into its fundamental chemical components prior to being mass analyzed. The separation device (typically a gas or liquid chromatograph), performs a chemical separation process and then directs the components of the sample into an ion source. The ion source is used to place the sample molecules into an ionized state whereupon the individually charged molecules may then be controlled through use of externally applied electric and/or magnetic fields.

After the ionized molecules leave the ion source they are directed into the analyzer, where the mass/charge ratios of the individual molecules will be measured. This analysis step may involve the use of a single or multiple set of quadrupole rods, a magnetic and/or electric analyzer, an electric trapping device, an ion mobility cell, a time-of-flight measuring device, or any combination or concatenation of these and other analyzers.

Many types of mass spectrometry analyzers require an RF generator capable of generating a high voltage RF signal. The quadrupole analyzer requires a bipolar RF signal to be applied to two of the four quadrupole rods comprising the analyzer. For the linear ion trap mass spectrometer, a bipolar RF signal must also be applied to two of the four quadrupole rods comprising the analyzer. For the three-dimensional ion trap mass spectrometer a unipolar RF signal must be applied to the ring electrode. For the rectilinear ion trap a bipolar RF signal must be applied to two of the four flat plate electrodes comprising the analyzer. For a cylindrical ion trap a unipolar RF signal must be applied to the center cylindrical conductor.

After passing through the analyzer of the mass spectrometer the ions are then detected. The detection process may involve the use of an electron multiplier, a Faraday cup detector, or a special charge-coupled device detector. The ion detection process may even involve the measurement of image currents generated externally to the analyzer due to the cyclic movement of the ions within the analyzer itself.

There are several types of mass spectrometers that utilize a high voltage RF field within the analyzer. One type of analyzer (the quadrupole mass filter) comprises a set of four or more conductive rods arranged in a parallel fashion, in which the sample molecules pass down the central axis of the rod assembly. This type of analyzer is typically used as a mass filter, in which ions are selectively removed from the sample stream, leaving a resulting mass spectrum to be recorded by an external detector.

Another type of analyzer that utilizes a high voltage RF field is the linear ion trap. This type of analyzer is similar to the quadrupole mass filter, except that the sample ions do not pass through the analyzer, and are instead “trapped” within the rod assembly through use of electric fields created at each end of the rod assembly. These trapped ions are then ejected sequentially in increasing mass/charge ratios from the rod assembly, generating a mass spectrum.

An additional type of analyzer requiring the use of a high voltage RF field is often referred to as the three-dimensional ion trap. This device is fundamentally a linear ion trap in which the cross-sectional geometry of the analyzer is rotated through a full 360 degrees, creating an enclosed trapping device comprising two “end cap” electrodes at opposite ends of the analyzer, with a “ring” electrode in the center. Sample molecules are either injected into the three-dimensional ion trap in an ionized state, or are injected as neutral molecules and then ionized internally after they have been injected into the ion trap.

The geometry of the quadrupole mass filters and ion traps can vary substantially. The quadrupole mass filter and linear ion trap can comprise conductive rods that are round, hyperbolic, or completely flat. Likewise, the three-dimensional ion trap can be constructed from round, hyperbolic, or cylindrical geometries.

The mass spectrometers based upon the quadrupole mass filter, or ion trap design, constitute a very large number of commercial mass spectrometers in current use. All of these instruments require the use of a high voltage RF power supply capable of supplying a fixed frequency signal that can be quickly varied in amplitude to match the desired scan rate of the instrument or to select a different operating condition.

### SUMMARY OF THE INVENTION

The disclosed RF generator design represents an efficient method of generating a high voltage RF signal of several thousand volts peak-to-peak. The design requires very few components and maintains excellent stability over the entire amplitude range of its output.

The disclosed RF generator circuit is driven by a low voltage (0 to 10 volts peak-to-peak) RF signal representing the desired frequency and amplitude of the output signal. The output of the RF generator will have the same frequency as the input driving signal, but will have a voltage output of roughly a thousand times that of the input signal.

The disclosed RF generator circuit is biased as a class AB amplifier in which the amplifier components themselves conduct for slightly more than one half of the input sinusoidal waveform period. By comparison, the typical class A amplifier will always conduct current and dissipate power throughout the entire input waveform cycle, even when the input signal is zero. The typical class B amplifier is composed of two different stages, in which one stage will conduct only during the positive portion of the input signal and the other stage will conduct only during the negative portion of the input signal. This configuration improves upon the efficiency of the class A amplifier at the expense of linearity. However, the class AB amplifier design permits the amplifier circuit to maintain both high efficiency and linearity, which represents an optimum design for an RF generator used in a mass spectrometer, especially for a portable mass spectrometer where it is desired to minimize power consumption while maintaining adequate linearity of the RF generator signal.

The initial input drive signal, representing the frequency and amplitude of the RF output signal, is split into two separate channels by two separate rectifier circuits. The positive rectifier circuit generates the positive component of the RF signal while the negative rectifier circuit generates the negative component of the RF signal.

Each of the positive and negative rectified signals drive a bias voltage circuit which allows exact control over the offset of positive and negative signals. These offset adjustments are important in achieving optimum linearity of the generated RF output signal.

The output of each of the positive and negative bias voltage circuits drive a separate current amplifier composed of an input buffer operational amplifier and a power MOSFET, which achieves a current amplification of approximately one amp of current for each one volt of RF input signal. In addition, the two current amplifier circuits employ a simplified feedback control loop permitting adequate stability of the generated RF signal with a very limited number of components.

The output of the two current amplifier circuits are combined to drive the primary winding of the final air-core step-up transformer. The secondary winding of the step-up transformer generates the final RF output signal which will normally be used to drive the electrodes of a quadrupole or ion trap mass spectrometer. Additionally, the RF generator may be used to drive an array of miniaturized 3-dimensional quadrupole ion trap mass spectrometers or linear ion trap mass spectrometers.

### BRIEF DESCRIPTION OF THE DRAWINGS

FIG. 1 shows a basic block diagram of the complete RF generator design. This includes the input sine wave signal, the positive and negative rectifier circuits, the bias voltage circuits, the current amplifiers and the final step-up transformer.

FIG. 2 shows the electronic circuit for the positive rectifier circuit.

FIG. 3 shows the electronic circuit for the negative rectifier circuit.

FIG. 4 shows the electronic circuit for the positive portion of the bias voltage circuit.

FIG. 5 shows the electronic circuit for the negative portion of the bias voltage circuit.

FIG. 6 shows the electronic circuit for the positive portion of the current amplifier circuit.

FIG. 7 shows the electronic circuit for the negative portion of the current amplifier circuit.

FIG. 8 shows the primary and secondary windings of the final air-core step-up transformer.

FIG. 9 shows an example of an RF generator driving a linear ion trap mass spectrometer composed of four quadrupole rods.

FIG. 10 shows the feedback paths in both the positive and negative current amplifier sections of the RF generator circuit, which is used to stabilize the RF generator output signal.

### DETAILED DESCRIPTION OF THE INVENTION

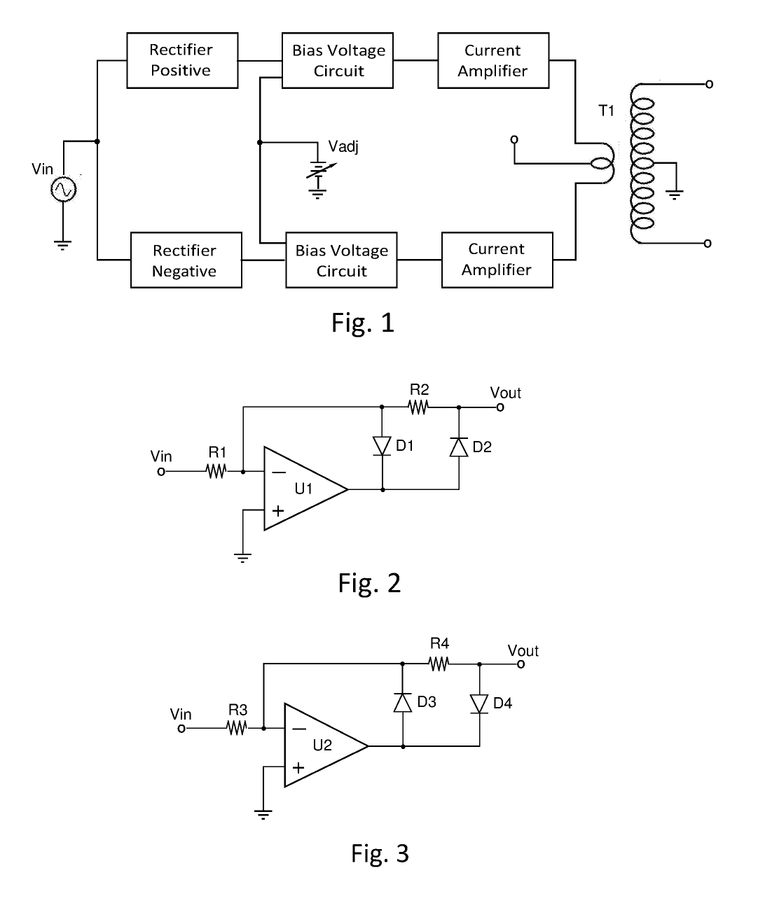

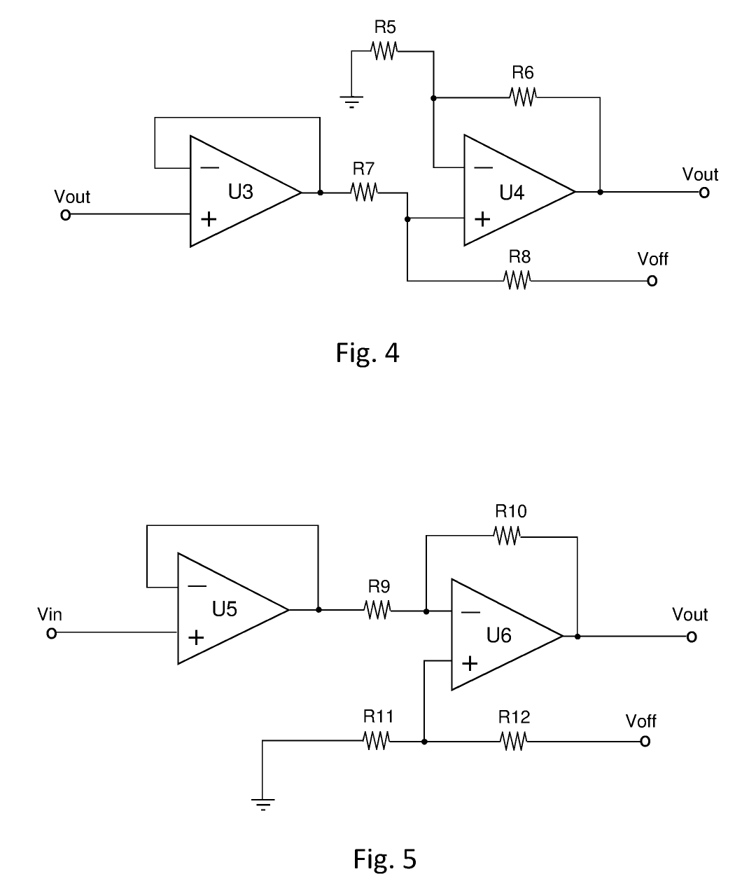

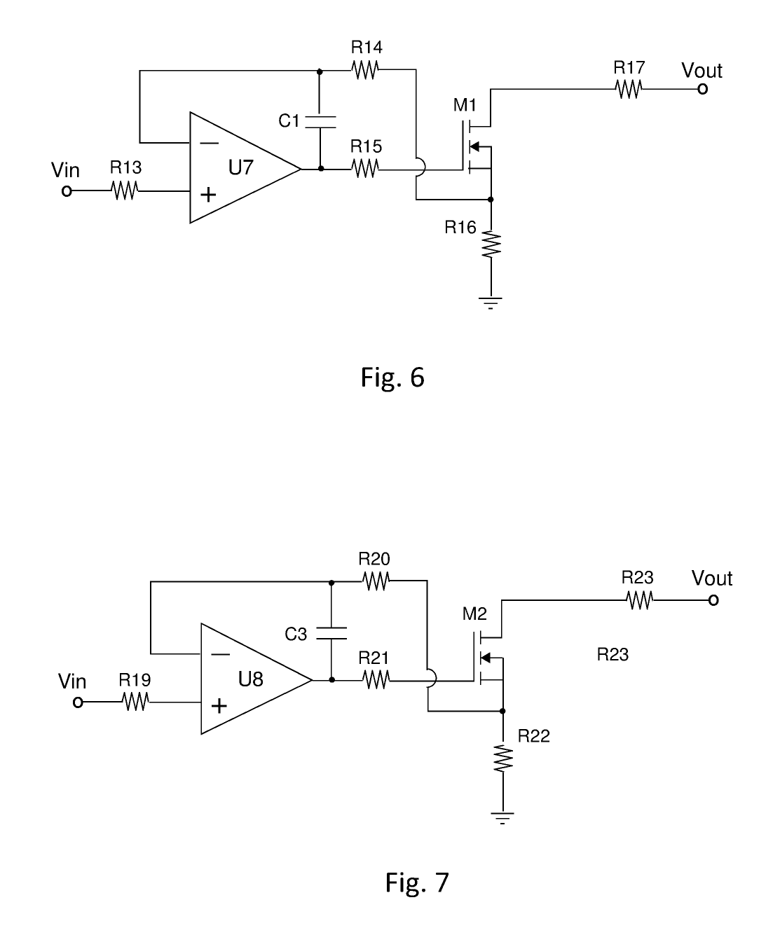

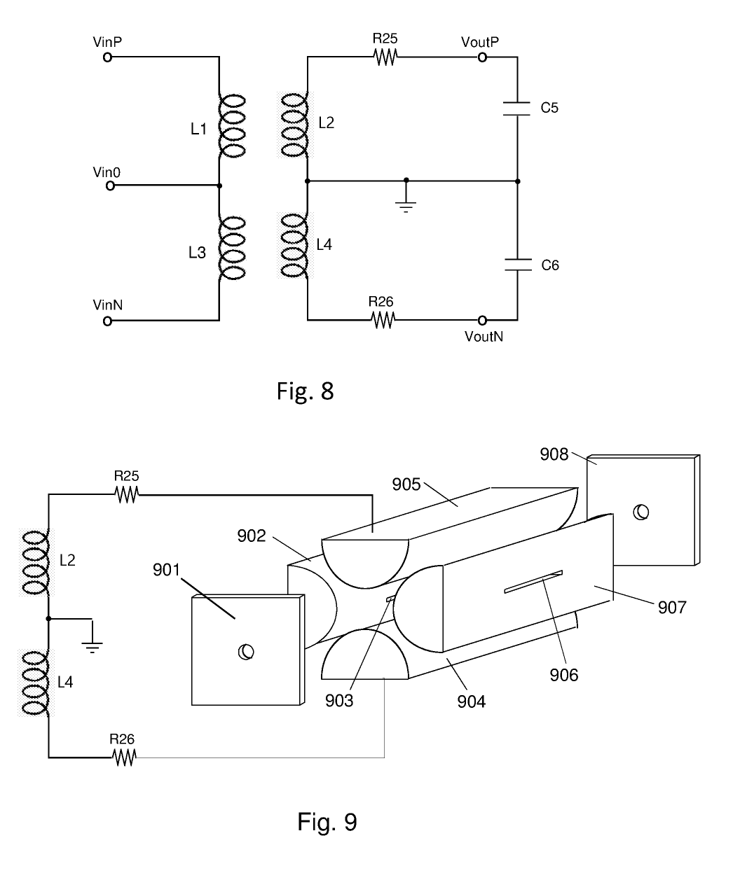

The RF generator circuit primarily comprises four different sections, as illustrated in FIG. 1. These sections are the rectifier section, as shown in detail in FIG. 2 and FIG. 3; the bias voltage circuitry, as shown in detail in FIG. 4 and FIG. 5; the current amplifiers, as shown in detail in FIG. 6 and FIG. 7; and the final step-up transformer, as shown in detail in FIG. 8.

The input driving signal is shown in FIG. 1 as Vᵢₙ. Vᵢₙ sets the frequency at which the RF generator will operate and will normally be a fixed frequency with a controllable amplitude. Typical values for an RF generator used to drive a quadrupole, or ion trap, mass spectrometer, will be in the one megahertz range. However, for some mass spectrometers the RF signal might be as low as 100 kHz. or as high as 10 MHz.

While the frequency of the Vᵢₙ signal used to drive the RF generator has a fixed frequency, the amplitude of the Vᵢₙ signal will normally vary from zero volts to a maximum input of ten or fifteen volts peak. The desired output of the RF generator will depend upon the physical size of the quadrupole or ion trap electrodes and the intended application of the mass spectrometer. Typical ion trap mass spectrometers could be driven by an RF signal having an amplitude of a few hundred volts, or as much as ten thousand volts peak-to-peak.

The RF driving signal, as shown in FIG. 1, is split into two separate signal channels by the positive and negative rectifier circuits. The positive rectifier circuit is shown in detail in FIG. 2 and the negative rectifier circuit is shown in detail in FIG. 3. The positive rectifier circuit generates a signal consisting solely of the positive portion of the RF input signal, while the negative rectifier circuit generates a signal consisting solely of the negative portion of the RF input signal.

The positive rectifier circuit is shown in detail in FIG. 2. It comprises the operational amplifier U1; the input resistor R1; the feedback resistor R2 and the detector diodes D1 and D2. The negative rectifier circuit is shown in detail in FIG. 3. It comprises the operational amplifier U2; the input resistor R3; the feedback resistor R4 and the detector diodes D3 and D4. Typical values for all four resistors would be 1000 ohms, but exact values will be dependent upon the particular application of the RF generator circuit. The four detector diodes; D1, D2, D3, D4 must be very fast Schottky detector diodes, such as the Hewlett-Packard HSMS-2860 diodes, or an equivalent.

The positive bias circuit shown in FIG. 4 is driven by the positive rectifier circuit shown in FIG. 2. The positive bias circuit comprises the two operational amplifiers U3 and U4, and the four resistors R5, R6, R7 and R8. An adjustable DC offset voltage, which will typically be only a few volts or less, must be connected to the circuit of FIG. 4 at V_{off}, through resistor R8, and adjusted to obtain optimum linearity of the RF output signal.

In a similar manner the negative bias circuit shown in FIG. 5 is driven by the negative rectifier circuit shown in FIG. 3. The negative bias circuit comprises the two operational amplifiers U5 and U6, and the four resistors R9, R10, R11 and R12. An adjustable DC offset voltage, which will typically be only a few volts or less, must be connected to the circuit of FIG. 5 at V_{off} through resistor R12, and adjusted to obtain optimum linearity of the RF output signal.

The offset voltages shown in FIG. 4 and FIG. 5 must be adjusted to maximize the linearity of the output RF waveform as the RF output passes through the zero crossing point. As discussed earlier, the disclosed RF generator circuit is biased as a class AB amplifier and must have its offset values properly adjusted to achieve maximum linear performance.

The output of the positive channel bias circuit shown in FIG. 4 is used to drive the input of the current amplifier section shown in FIG. 6. This current amplifier section is comprised of an input buffer circuit and a current amplifier MOSFET. The input buffer circuit comprises input resistor R13 and operational amplifier U7. The current amplifier itself comprises MOSFET M1 and resistors R14, R15, R16 and R17. Typical values for R13 would be 1000 ohms; R14 would be 500 ohms; R15 would be 22 ohms; R16 would be 0.5 ohms and R17 would be 0.1 ohms. While these values are typical they are not absolute requirements and significant differences can exist depending upon the parameters of the RF generator being developed. A typical current amplifier that could be used for MOSFET M1 would be the Vishay IRF530, although an equivalent power MOSFET having a bandwidth of at least 400 MHz could also be used.

The output of the negative channel bias circuit shown in FIG. 5 is used to drive the input of the current amplifier section shown in FIG. 7. The current amplifier section is comprised of an input buffer circuit and a current amplifier MOSFET. The input buffer circuit comprises input resistor R19 and operational amplifier U8. The current amplifier itself comprises MOSFET M2 and resistors R20, R21, R22 and R23. Typical values for R19 would be 1000 ohms; R20 would be 500 ohms; R21 would be 22 ohms; R22 would be 0.5 ohms and R23 would be 0.1 ohms. While these values are typical they are not absolute requirements and significant differences can exist depending upon the parameters of the RF generator being developed. A typical current amplifier that could be used for MOSFET M2 would be the Vishay IRF530, although an equivalent power MOSFET having a bandwidth of at least 400 MHz could also be used.

The disclosed current amplifier design with the suggested values and components will produce an amplifier design generating approximately one amp of current at the output of the power MOSFET devices for a 1 volt input. These values relate to a particular application and can be expected to change with differing design criteria.

The output of the two current amplifiers, shown in FIG. 6 and FIG. 7, are used to drive the input of the step-up transformer shown in FIG. 8. The primary winding of the step-up transformer comprises inductors L1 and L3, with a center tap shown connected to Vᵢₙ0. Vᵢₙ0 is used to set an input offset voltage to generate a symmetrical output voltage at the VₒᵤₜP (RF Voltage Out Positive) and the VₒᵤₜN (RF Voltage Out Negative) terminals.

The secondary winding of the step-up transformer comprises the two inductors L2 and L4, with a center tap conductor point connected to ground. The capacitive load of the ion trap electrodes is represented by C5 and C6 in FIG. 8. Typical values for R25 and R26 would be 0.2 ohms. Typical values for the capacitive load represented by C5 and C6 would be 80 pF, but for some mass spectrometers the capacitive load presented by the analyzer assembly could be as low as 10 or 20 pF. Typical inductance values for L1 and L2 would be 25 nH each, and typical inductance values for L2 and L4 would be 250 μH each. These are typical values; actual values could be different, depending upon the criteria of the RF generator being designed.

The turns ratio and the actual number of turns of the T1 step-up transformer will be primarily dependent upon the desired output voltage of the RF generator. This could vary from a few hundred volts for smaller quadrupole or ion trap mass spectrometer analyzers, to as much as ten thousand volts for larger analyzers. This would allow for a turns ratio that would typically range from 1:100 (primary to secondary) to 1:1000 (primary to secondary). However, for specialized applications the optimum turns ratio could be more or less than these values.

The drawing in FIG. 9 shows a typical method of using the RF generator circuit to drive a linear ion trap mass spectrometer. In the drawing, the output of the RF generator is produced in the secondary windings L2 and L4, and the bipolar RF signal is connected to the two quadrupole rods 905 and 904. The other two quadrupole rods, 902 and 907 are normally tied to ground potential, or to an AC field used during the scanning phase of data acquisition.

FIG. 9 also shows two “endcap” electrodes, 901 and 908, which are used to contain ions within the linear ion trap. In one embodiment of the linear ion trap, ionized molecules of the sample are injected into the linear trapping region through the circular aperture in the entrance endcap 901, and are contained within the center of the linear ion trap due to the RF field applied to the quadrupole rods, and the potentials applied to the endcaps 901 and 908 which serve to prevent the sample ions from leaving the linear trapping volume.

After ions have been contained within the trapping volume at the center of the quadrupole rod set, as shown in FIG. 9, the ions are then scanned out of the trapping volume by increasing the amplitude of the RF signal connected to the two rods 904 and 905. As the amplitude of the RF signal is increased, the trapped ions will be ejected through the small slits 903 and 906 in the rods 902 and 907. The ejected ions can then be collected and measured through use an ion detector, such as an electron multiplier, placed near the exit of either slit 903 or 906.

FIG. 9 displays only one of many possible methods by which an RF generator may be connected to a quadrupole mass spectrometer or ion trap mass spectrometer. The following Table 1 lists the various embodiments of the different quadrupole mass filters and ion trap mass spectrometers that may be operated with an RF generator of the type disclosed.

TABLE 1

| Analyzer Type | RF Requirements | Scanning Mode |
|---|---|---|
| Quadrupole Mass | Bipolar RF signal required. | Selects individual ions |
| Spectrometer | RF and DC both required. | during scanning phase. |
| Quadrupole | Bipolar or Unipolar RF. | Traps ions and then |
| Linear Ion Trap | | performs sequential scan. |
| Rectilinear Ion | Bipolar or Unipolar RF. | Traps ions and then |
| Trap | | performs sequential scan. |
| 3-D Ion Trap | Unipolar connection to | Traps ions and then |
| | hyperbolic ring electrode. | performs sequential scan. |
| 3-D Cylindrical | Unipolar connection to | Traps ion and then |
| Ion Trap | cylindrical ring electrode. | performs sequential scan. |

Table 1 lists five types of mass spectrometer configurations that can be driven with an RF generator of the type described herein. The first is the Quadrupole Mass Spectrometer, in which each of the two opposite pairs of rods of the quadrupole analyzer are connected together and the resulting two connections are driven by an RF and DC signal. The RF and DC potentials are increased in proper proportion to generate a mass spectrum by allowing only ions having a particular m/z value to pass through the analyzer at a given time, thus generating a mass spectrum.

The quadrupole linear ion trap has a similar construction to that of the quadrupole mass analyzer, but the quadrupole linear ion trap does not require the use of a DC potential. In addition, the quadrupole linear ion trap requires the use of two “endcaps”, or additional quadrupole segments to contain ions injected into the center of the quadrupole trapping volume. The quadrupole rods themselves may be circular, or preferably, hyperbolic in shape.

The rectilinear ion trap is constructed in a very similar manner to that of the quadrupole linear ion trap, but instead of four circular or hyperbolic rods, four flat conductive plates are used to construct the analyzer.

The 3-D (3-Dimensional) ion trap is constructed from two hyperbolic-shaped endcaps and a hyperbolic-shaped ring electrode. In this configuration, the RF generator only needs to supply one unipolar RF output signal to the ring electrode.

The 3-D cylindrical ion trap is constructed in a very similar manner to the 3-D ion trap, except that the two hyperbolic endcaps are replaced with simple flat circular plates with an aperture in the center to permit the entry and exit of ions, and the hyperbolic-shaped ring electrode is replaced with a simple circular ring electrode.

These descriptions represent most of the configurations used by quadrupole and ion trap mass spectrometers. Their exact detail is not pertinent to the description of the RF generator circuit described herein, but serves to demonstrate that the described RF generator circuit may be used to control a variety of mass spectrometer configurations, and may also be used to supply an RF signal to any type of instrument or device requiring a compact RF generator that can produce a variable high voltage signal at a low output current.

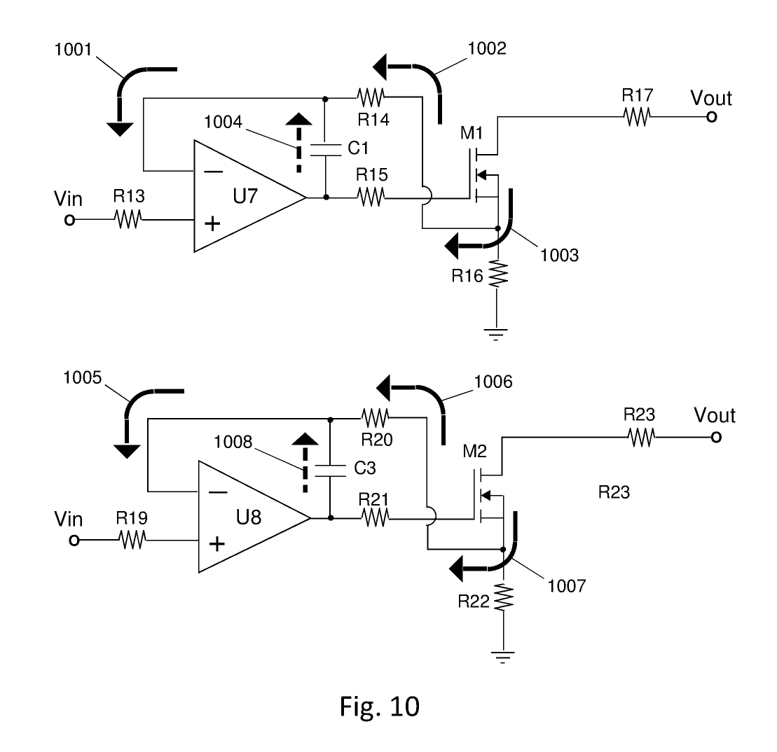

FIG. 10 shows the positive and negative current amplifiers with the feedback paths that are used to stabilize the RF generator output. For the positive signal channel a feedback control loop is generated by a current path flowing from the power MOSFET M1 back through R14 and to the inverting input of the operational amplifier U7, as shown by the arrows 1001, 1002, 1003. For the negative signal channel a feedback control loop is generate by a current path flowing from the power MOSFET M2 back through R20 and to the inverting input of the operational amplifier U8, as shown by the arrows 1005, 1006, 1007. As discussed earlier, the power MOSFETs M1, M2 must both have a bandwidth of at least 400 MHz, such as the Vishay IRF530.

The RF generator circuit is designed to handle a wide range of operating frequencies. A typical operating frequency would be 1 MHz, but the circuit could also be used for frequencies up to 10 MHz. For frequencies above approximately 6 MHz, the feedback loop incorporates an additional current path. For the positive signal component, feedback flows back through C1 to the inverting input of U7, as shown by the dashed arrow 1004. For the negative signal component, feedback flows back through C3 to the inverting input of U8, as shown by the dashed arrow 1008.

The feedback control loop of the disclosed circuit is able to maintain stability and linearity of the RF generator amplitude by incorporating very fast power MOSFETS and sampling the RF output at the input to the primary winding of the final step-up transformer. This allows the RF generator design to operate with sufficient stability to control a portable mass spectrometer, without the need for a sampling circuit connected to the secondary winding of the RF generator final step-up transformer. Since a portable mass spectrometer typically presents a small load for an RF generator (often less than 20 pf.), the disclosed design is capable of generating an RF signal with excellent stability through use of the feedback loop described, which originates at the input to the primary winding of the final step-up transformer.

The component values described herein represent sample values that can be used to construct an operating RF generator circuit. Various optimizations and adjustments may be made to allow the RF generator performance to be more compatible with any particular application.

1. An RF generator circuit optimized to produce a high voltage, fixed frequency, controllable amplitude signal having minimum power consumption comprising the following sequential components:
a) a signal input source having a fixed frequency with a controllable amplitude used to set the output frequency of said RF generator circuit and to control said RF generator circuit output amplitude,
b) a rectifier circuit stage splitting said signal input source into two separate signal channels comprising the positive and negative excursions of said signal input source,
c) a bias circuit stage to provide an adjustable DC offset to each of said two separate signal channels,
d) an amplifier stage containing two separate current amplifiers used to amplify the output current of each of said two separate signal channels,
e) a feedback path originating at the output of each of said two separate current amplifiers and feeding back to the input of each of said two separate current amplifiers,
f) a step-up transformer used to combine said current amplifier outputs and amplify said combined signal generating an RF output signal.

2. The RF generator circuit of claim 1 in which said RF generator circuit is operated in class AB mode.

3. The RF generator circuit of claim 1 in which said step-up transformer is an air-core transformer comprised of a primary and secondary winding, with said primary winding and said secondary winding each having a center-tap conductor.

4. The RF generator circuit of claim 1 in which said RF output signal is used to drive the electrodes of a quadrupole mass spectrometer.

5. The RF generator circuit of claim 1 in which said RF output signal is used to drive the electrodes of a 2-dimensional linear ion trap mass spectrometer.

6. The RF generator circuit of claim 1 in which said RF output signal is used to drive the ring electrode of a 3-dimensional ion trap mass spectrometer.

7. The RF generator circuit of claim 1 in which said RF output signal is used to drive an array of miniaturized ion trap mass spectrometers.

8. A method of generating an RF output signal by utilizing a separate pair of current amplifiers controlled by a feedback path originating from the output of each of said separate pair of current amplifiers and feeding back to the input of said separate pair of current amplifiers.

9. The method of claim 8 in which said separate pair of current amplifiers is operated in class AB mode.

10. The method of claim 8 in which said RF output signal is used to drive the electrodes of a quadrupole mass spectrometer.

11. The method of claim 8 in which said RF output signal is used to drive the electrodes of a 2-dimensional linear ion trap mass spectrometer.

12. The method of claim 8 in which said RF output signal is used to drive the ring electrode of a 3-dimensional ion trap mass spectrometer.

13. The method of claim 8 in which said RF output signal is used to drive an array of miniaturized ion trap mass spectrometers.

14. A method of generating an RF output signal by performing the following sequential functions:
a) separation of the RF input signal into separate positive and negative signal channels,
b) adjustment of the DC offset of each of said separate positive and negative signal channels to achieve optimum linearity of said RF output signal,
c) amplification of each of said positive and negative signal channels by using two separate current amplifiers,
d) implementation of two feedback paths originating at the output of each said current amplifier and feeding back to the input of each said current amplifier,
e) combining said separate positive and negative signal channels using the primary winding of an air-core step-up transformer,
f) generating said RF output signal from the secondary winding of said air-core step-up transformer.

15. The method of claim 14 in which said separate current amplifiers are operated in class AB mode.

16. The method of claim 14 in which said RF output signal is used to drive the electrodes of a quadrupole mass spectrometer.

17. The method of claim 14 in which said RF amplifier is used to drive the electrodes of a 2-dimensional linear ion trap mass spectrometer.

18. The method of claim 14 in which said RF amplifier is used to drive the ring electrode of a 3-dimensional ion trap mass spectrometer.

19. The method of claim 14 in which said RF amplifier is used to drive an array of miniaturized ion trap mass spectrometers.
